(19) United States
(12) Patent Application Publication
(10) Pub. No.: US 2015/0357894 A1
(43) Pub. Date: Dec. 10, 2015

(54) HYBRID STEPPING MOTOR

(71) Applicant: SHANGHAI MOONS ' ELECTRIC CO., LTD., Shanghai (CN)

(72) Inventors: Yongsong WU, Shanghai (CN); Yu ZHANG, Shanghai (CN)

(21) Appl. No.: 14/759,893

(22) PCT Filed: Jan. 6, 2014
(86) PCT No.: PCT/CN2014/070144

§ 371 Date: Jul. 8, 2015

(30) Foreign Application Priority Data
Jan. 9, 2013 (CN) 201310007662.7

(51) Int. Cl. H02K 37/00; H02K 3/46; H02K 3/30; H02K 1/12

(52) U.S. Cl. CPC H02K 37/00; H02K 1/12; H02K 3/46; H02K 3/30

(57) ABSTRACT

A hybrid stepping motor comprises a front-end cover, a rear end cover, a rotating shaft, a rotor, a stator, a front bearing and a rear bearing and magnet steel, wherein the stator is an injection-molded stator. A stator core is internally provided with a plurality of injection-molded frameworks for bearing an enameled wire winding. Each injection-molded framework is provided with an enameled wire guard board on the inside. The inner side of each enameled wire guard board forms an inner hole of the stator and each enameled wire guard board serves as a seam for motor assembling. In the case of the same motor thickness, use of the motor of the present invention can enhance the moment by 15%˜45%. In the case of the same moment, use of the motor of the present invention can reduce the thickness by 10%˜15%. Thus, iron loss can be reduced when the motor is running.

### BACKGROUND OF THE INVENTION

1. Technical Field

The present invention relates to a motor, in particular to a hybrid stepping motor.

2. Description of Related Art

A hybrid stepping motor (hereinafter referred as motor) can employ two modes to locate its front and rear end covers, the stator core and the rotor: external seam and internal seam.

The basic structure of the motor with the external seam can be seen in FIG. 1, comprising a front-end cover 1, a rear end cover 2, a rotating shaft 3, a rotor 4, a stator 5, a front bearing 6, a rear bearing 7 and magnet steel 8. Seams 11 and 21 of the front-end cover 1 and rear end cover 2 are assembled with the external circle of the iron core of the stator 5, and a bearing chamber of the end cover locates the rotor, so the rotor is located at the center of an inner hole of the iron of the stator. Air gaps of the hybrid stepping motor are usually unilaterally some 0.03-0.05 mm; the motor with external seam requires that the inner hole and the external circle of the stator meet very high requirements for concentricity (the concentricity is about 0.015); if the 0.015 is poor, motor blockage, loud noises and shortened service life are easily caused.

The basic structure of the motor with the internal seam can be seen in FIG. 2, comprising a front-end cover 1, a rear end cover 2, a rotating shaft 3, a rotor 4, a stator 5, a front bearing 6, a rear bearing 7 and magnet steel 8. The seams 12 and 22 on the inner wall of the bearing chamber of the end cover are directly matched with the inner hole of the stator core, theoretically reducing the transmission of a processing to allowance and greatly improving the assembling quality of the motor. However, the seam directly contacts the inner hole of the stator, and to meet the high requirements for strength, the seam is required to extend into the inner hole of the iron core by about 1.5-2.5 mm. Therefore, for a series of motors of the same specifications, on condition of the same rotor length, the stator core of the motor with the internal seam is about 3-5 mm thicker than the thickness of the stator core of the motor with the external seam (front and rear end covers), which fails to meet the requirements for small size of the motor to a certain degree.

### BRIEF SUMMARY OF THE INVENTION

The objective of the present invention is to provide a hybrid stepping motor to solve the problems in the prior art.

To fulfill the above objective, the present invention employs the following technical solution: A hybrid stepping motor, comprising a front-end cover, a rear end cover, a rotating shaft, a rotor, a stator, a front bearing, a rear bearing and magnet steel. The stator is an injection molded stator. A stator core is internally provided with a plurality of injection-molded frameworks for bearing an enameled wire winding. Each injection-molded framework is provided with an enameled wire guard board on the inside. The inner side of each enameled wire guard board forms an inner hole of the stator and each enameled wire guard board serves as a seam for motor assembling.

Each enameled wire guard board is a circular arc-shaped framework member, consisting of two circular arc-shaped strips and a plurality of axial strips connected between the two circular arc-shaped strips, and the two ends of each of the two circular arc-shaped strips are respectively provided with a groove.

The axial length of each enameled wire guard board is greater than the thickness of the stator core and extends along the two sides of the stator core.

Employing the above technical solution, the present invention has the following advantages and characteristics:

1. In the case of the same motor thickness, use of the motor of the present invention can enhance the moment by 15%˜45%. In the case of the same moment, use of the motor of the present invention can reduce the thickness by 10%˜15%.

2. Using the motor of the present invention, the thickness of the stator core can be shortened while the moment ensured, thus reducing the ferric loss when the motor is running.

### BRIEF DESCRIPTION OF THE SEVERAL VIEWS OF THE DRAWINGS

FIG. 1 is a structural view of a motor with the external seam in the prior art;

FIG. 2 is a structural view of a motor with the internal seam in the prior art;

FIG. 3 is a structural view of a hybrid stepping motor of the present invention;

FIG. 4 is a schematic view of the basic structure of the injection-molded stator in the present invention.

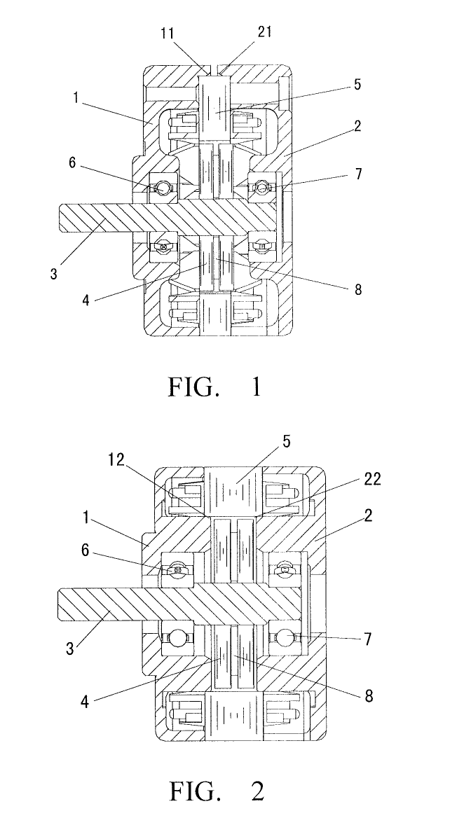

### DETAILED DESCRIPTION OF THE INVENTION

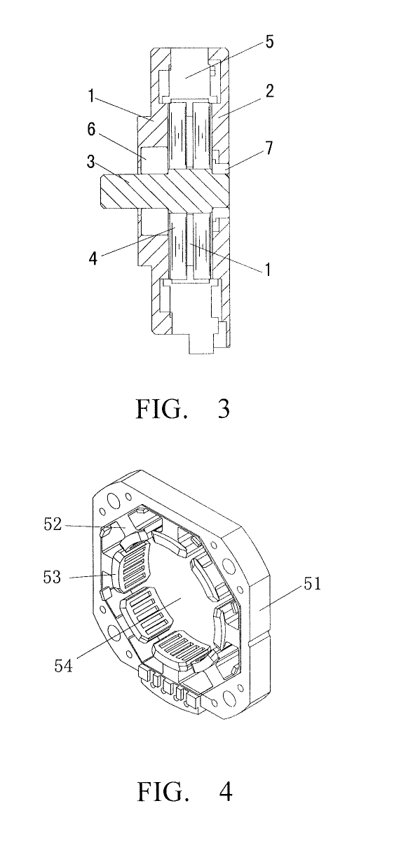

See FIGS. 3 and 4. A hybrid stepping motor in the present invention comprises a front-end cover 1, a rear end cover 2, a rotating shaft 3, a rotor 4, a stator 5, a front bearing 6, a rear bearing 7 and magnet steel 8; wherein the stator 5 is an injection-molded stator. A stator core 51 is internally provided with a plurality of injection-molded frameworks 52 for bearing an enameled wire winding. Each injection-molded framework is provided with an enameled wire guard board 53 on the inside. The inner side of each enameled wire guard board 53 forms an inner hole 54 of the stator; and each enameled wire guard board serves as a seam for motor assembling.

Each enameled wire guard board 53 is a circular arc-shaped framework member, consisting of two circular arc-shaped strips and a plurality of axial strips connected between the two circular arc-shaped strips, and the two ends of each of the two circular arc-shaped strips are respectively provided with a groove. The axial length of each enameled wire guard board is greater than the thickness of the stator core and extends along the two sides of the stator core.

On the basis of the advantages of the motor with the internal seam in the prior art, in the present invention, the frameworks are injection molded through the stator core, and the enameled wire guard board structures on the frameworks serve as the seam for motor assembling. Therefore, the guard board structures are necessary structures for coiling of the enameled wire winding, without affecting the space between the end covers and the winding and reducing the thickness of the original motor with the internal seam.

What is claimed is:

1. A hybrid stepping motor, comprising a front end cover, a rear end cover, a rotating shaft, a rotor, a stator, a front bearing, a rear bearing and magnet steel; characterized in that, the stator is an injection molded stator; a stator core is internally provided with a plurality of injection molded frameworks for bearing an enameled wire winding. Each injection-molded framework is provided with an enameled wire guard board on the inside. The inner side of each enameled wire guard board forms an inner hole of the stator and each enameled wire guard board serves as a seam for motor assembling.

2. The hybrid stepping motor according to claim 1, each enameled wire guard board is a circular arc-shaped framework member, consisting of two circular arc-shaped strips and a plurality of axial strips connected between the two circular arc-shaped strips, and the two ends of each of the two circular arc-shaped strips are respectively provided with a groove.

3. The hybrid stepping motor according to claim 1, the axial length of each enameled wire guard board is greater than the thickness of the stator core and extends along the two sides of the stator core.
